(19) United States
(12) Patent Application Publication
(10) Pub. No.: US 2005/0262002 A1
(43) Pub. Date: Nov. 24, 2005

(54) Process, system and financial engine for determining a level of risk in the market, and for adjusting user's market exposure based on the level of risk

(76) Inventors: William Manning, Penfield, NY (US); Jeffrey S. Coons, Rochester, NY (US); Michele R. McGinn, East Rochester, NY (US)

Correspondence Address: BAKER & BOTTS, 30 ROCKEFELLER PLAZA, NEW YORK, NY, 10112, US

(21) Appl. No.: 10/851,729

(22) Filed: May 20, 2004

(51) Int. Cl. G06F 17/60

(52) U.S. Cl. 705/36

(57) ABSTRACT

A process, system and financial engine which determine a portfolio's sensitivity to market risk based on market conditions are described. In particular, with these process, system and financial engine, first data representative of time horizon information and second data representative of risk tolerance information are first received, and guidelines data based on the first and second data are established. Economic and market data underlying the quantitative indicators and factors determining the qualitative indicators are received. Market risk signals based on the indicator(s) is then established. The portfolio's sensitivity is determined based on the established guidelines data and the market risk signal. Using these process, system and financial engine, it is possible to determine the current market risk level, and then recommend changes to (or adjust) the user's portfolio market risk sensitivities based on the user's time horizon (i.e., the need to access their assets within a particular time) and the determined market risk level.

### FIELD OF THE INVENTION

The present invention relates to a system, process and financial engine for determining a level of risk in the market, and for adjusting user's market exposure based on the level of risk. In particular, the system, process and financial engine first determine the current market risk level, and then recommend changes or adjust the user's portfolio sensitivity based on the user's time horizon (e.g., the need to access their assets within a particular time) and the determined market risk level.

### BACKGROUND INFORMATION

Conventional methods, systems and financial engines to establish an appropriate level of a market risk for a given portfolio have been primarily centered around an establishment of a mean-variance efficient asset allocation model of assets intended to achieve a particular level of market risk as well as a target rate of return for a user (e.g., a client). This technique is known as a mean-variance optimization technique which is based on a known Capital Asset Pricing Model and which utilizes either previously collected data corresponding to the return, variance and covariance of different asset types or the analyst's expected values for those variables. The previously collected data or the analyst's expected values are then used as input parameters for an asset allocation model. The asset allocation model provides an output which is a mix of asset types. This mix of asset types have an optimal level of an expected return for a given level of the market risk, or a minimal level of the market risk that is required to achieve a particular level of the expected return. This conventional approach has been extensively used in the investment industry; however, it fails to take into consideration the fact that the markets tend to move in cycles.

Thus, the appropriate level of the market risk exposure for a particular portfolio with a predefined horizon is dependent upon the level of risk in that market at a given point in time. In addition, the above-described mean-variance technique is heavily dependent on the input of returns expected by the user. Indeed, small errors in the expected return may highly influence the output of the mean-variance technique. Thus, the client would be relying heavily on a variable that is highly unpredictable, whether or not the historical data or the analyst's best estimates of the future returns are used in the optimization.

Another conventional technique for determining a level of the market risk for the user is known as a “market timing model”. In this model, the economic and market indicators are used to identify which asset type is expected to provide the highest return over a predetermined time period (e.g., next month, next quarter, etc.). In a typical market timing model, certain rules are established based on certain variables such as stock market valuations, liquidity, economic growth, etc. Using these rules, a decision can be made as to when to raise or lower the user's exposure to various asset classes. The market timing model addresses the fact that the markets move in cycles, and it takes advantage of those cycles by attempting to shift from assets of one asset class at the peak of its cycle to another asset class at the bottom of its cycle. However, this model generally is based on pursuing returns, and typically does not differentiate between users who have different time horizons. Specifically, the conventional market timing models attempt to maximize the user's returns by shifting the user's exposure to various asset classes, rather than to minimize the risk of certain sustained declines or negative risk-adjusted returns over the user's time horizon.

Accordingly, there is a need to provide a system, process and financial engine for determining the level of risk in the market, and for adjusting the client's market exposure based on the determined level of risk. For example, contrary to the above described conventional techniques, such determination can be made using the client's entered time horizon, investment objectives/risk tolerance and at least one economic indicator. In addition, the user's market exposure can be adjusted (or such adjustment can be recommended) based on the determined risk level and the user's time horizon and risk tolerance.

### SUMMARY OF THE INVENTION

According to the present invention, a process, system and financial engine are provided which determine a portfolio's sensitivity to market conditions. In particular, with these process, system and financial engine, first data representative of time horizon information and second data representative of risk tolerance information are first received, and guidelines data based on the first and second data are established. Data underlying the quantitative indicators and factors determining the qualitative indicators are received. At least one indicator which is an economic indicator and/or a market indicator can also be established. Then, at least one market risk measure based on at least one indicator is established, and the portfolio's sensitivity is determined based on the established guidelines data and the level of market risk. As a result, using these process, system and financial engine, it is possible to determine the current market risk level, and then recommend certain changes to the user's portfolio sensitivity (or actually adjust the portfolio's sensitivity) based on the determined market risk level, the user's time horizon (i.e., the user's need to access his or her assets within a particular time) and possibly risk tolerance (e.g., the willingness/ability to withstand sustained loss of capital). The portfolio sensitivity can be referred to as the portfolio's Beta. Beta can be adjusted by increasing or decreasing the portfolio's exposure to equity investments with respect to the total investments in the portfolio. An adjustment to Beta can be referred to as “BetaSliding^{SM}”, and may be further described as a systematic reduction and/or increase of market risk (i.e., Beta) for the client as the risk in that market increases or declines. One of the advantages of this exemplary embodiment is that it allows the environment-sensitive assessments to be made regarding an appropriate mix of the asset types for a given set of the user's time horizon and/or risk tolerance characteristics.

In another embodiment of the present invention, a target Beta value for the portfolio is determined based on the portfolio's objectives and time horizon. The target Beta value may represent a ratio of equity-type investments with respect to the total investments in the portfolio, and can also be adjusted based on the guidelines data and the market risk signal. In addition, recommendations can be provided to an owner of the portfolio based on the portfolio's time horizon/risk tolerance. In this manner, it is possible to determine if the Beta value should be adjusted or maintained the same.

According to a further embodiment of the present invention, the portfolio includes equity-type investments and/or bond-type securities. In addition, the portfolio's sensitivity can relate to the amount of the equity-type investments in the portfolio.

In a further embodiment of the present invention, the portfolio includes equity-type investments and/or bond-type securities and/or securities from one or more foreign markets for an overall asset allocation that relates to the portfolio's sensitivity to market risk for various foreign markets.

In a further embodiment of the present invention, the portfolio includes equity-type investments of various sectors and/or bond-type securities for an overall asset allocation that relates to the portfolio's sensitivity to market risk for various equity sectors.

In yet another embodiment of the present invention, the portfolio's sensitivity can be stored in a storage device, and at least one further indicator may be received (which is a further economic indicator and/or a further market indicator). Then, the stored portfolio's sensitivity can be further adjusted based on such further indicator, and may correspond to a Beta value of the portfolio. Thereafter, the stored portfolio's sensitivity is adjusted by providing recommendations to an owner of the portfolio based on the portfolio's sensitivity so as to determine if the Beta value should be adjusted. The Beta value can also be adjusted based on this further indicator.

In still another embodiment of the present invention, the first data may include information regarding a time period when an owner of the portfolio expects to liquidate a significant portion of the portfolio. The second data may include information regarding a degree of volatility in the market that the owner of the portfolio is willing accept. The indicator may include a plurality of indicators, each of which is identified to be in at least one of the following categories—a Hurdle Rate category, a Valuation category, a Speculation category, and a Liquidity category. The portfolio's sensitivity may corresponds to the Beta value of the portfolio, and the market risk signal indicates an increased market risk (e.g., a “Red” light), a decreased market risk (e.g., a “Green” light), and a neutral market risk (e.g., a “Yellow” light) via a Traffic Light model indicator. In yet another embodiment of the present invention, the market risk signal is established based on historical cycles of the market.

In one further exemplary embodiment, the system, process and financial engine according to the present invention also adjusts the exposure of the user's portfolio to various market risks based upon the portfolio's investment time horizon and the level of risk for a given market in the current environment. A reduction of the Beta value can be referred to as “BetaSliding^{SM}”, and may be further described as a systematic reduction and/or increase of market risk (i.e., the Beta value) for the client as the risk in that market increases or declines. One of the advantages of this exemplary embodiment is that it allows the environment-sensitive assessments to be made regarding, e.g., an appropriate mix of the asset types for a given set of the user's time horizon/risk tolerance characteristics.

It should be understood that each embodiment of the present invention can be implemented using a Web-enabled or Web-based system such that it can be accessed by the users and managers thereof via the Internet or intranet, and the data can also be retrieved by the system, or provided thereby via the Internet or intranet.

### BRIEF DESCRIPTION OF THE DRAWINGS

Exemplary embodiments of the present invention will now be described in detail with reference to the accompanying drawings in which:

FIG. 1 shows an exemplary embodiment of a system according to the present invention which determines a level of risk in the market, and possibly adjusts the user's market exposure based on, the level of market risk.

FIG. 2 shows an exemplary embodiment of a process according the present invention which determines a level of risk in the market, which possibly adjusts the user's market exposure based on the level of risk, and which is executable by the system illustrated in FIG. 1.

FIG. 3 shows an illustration of exemplary queries that can be provided to the user or users to establish time horizon, asset allocation guidelines and/or market exposure guidelines.

FIG. 4 shows an exemplary table of certain combinations of answers that can be obtained for the questions provided to the user or users in FIG. 3.

FIG. 5 shows an exemplary diagram of economic and market indicators retrievable by the system, process and financial engine of the present invention.

FIG. 6 shows an exemplary diagram of the use for the economic and market indicators shown in FIG. 5 to generate signal data so as to determine the portfolio's sensitivity (and a possible adjustment thereof).

FIG. 7 shows an exemplary table for determining a possible equity allocation which utilizes the table shown in FIG. 4, as well as the portfolio's sensitivity as determined in FIGS. 2 and 6.

### DETAILED DESCRIPTION

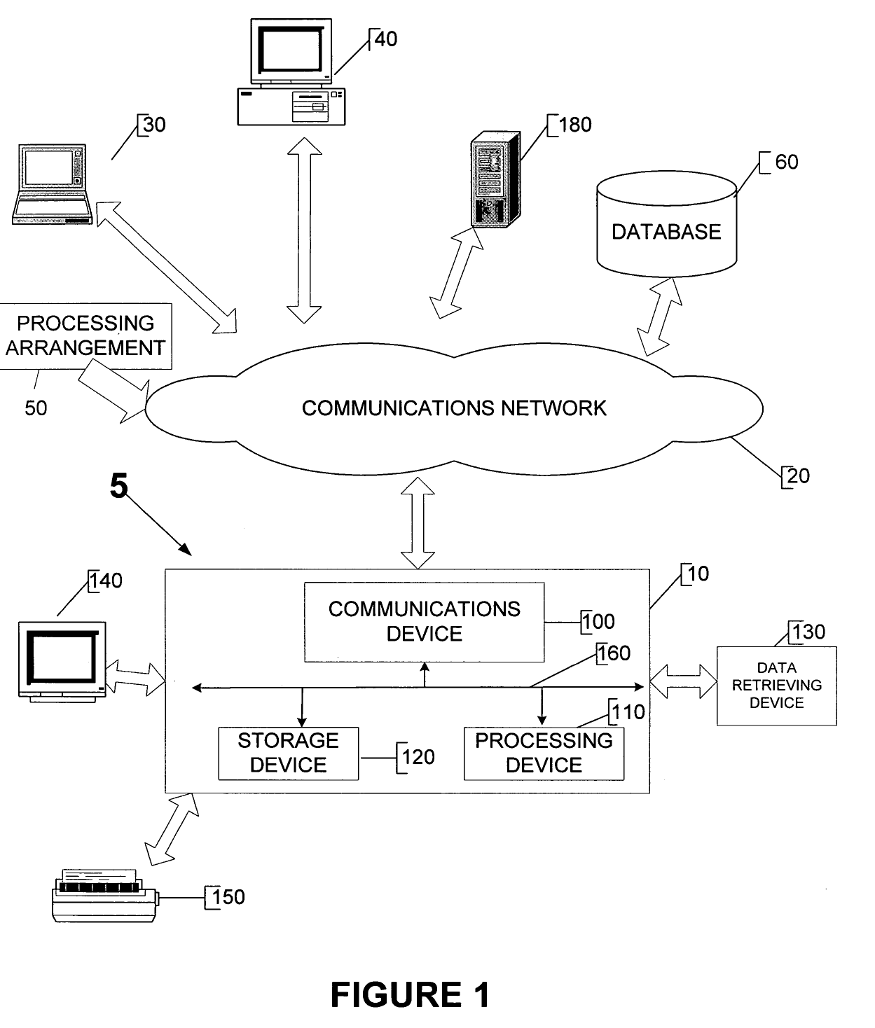

FIG. 1 shows an exemplary embodiment of a system 5 according to the present invention which determines a level of risk in the market, and possibly adjusts user's market exposure based on the level of the market risk (e.g., “Beta”), the user's time horizon and risk tolerance. Beta can be defined as a measure of systematic risk based on the covariance of a portfolio in relation to a given market. In other words, Beta is a measurement of a portfolio's sensitivity to the volatility of a given market (e.g., the stock market). For example, a Beta of zero to the United States stock market may indicate that the user owns no equity-type financial assets (e.g., stocks), but rather holds only cash. Whereas, a Beta of 1.0 may indicate that the user owns 100% in equity-type financial assets with similar financial characteristics to the overall market. Further, a Beta of 0.8 may indicate that 80% of the user's assets are such equity-type assets, while Beta of 0.3 may signify that only 30% of the user's assets are such equity-type assets. In addition, a Beta of 1.2 may signify that 120% of the user's assets are equity-type assets, with a loan equal to 20% of assets used to purchase additional equity-type assets.

The system 5 includes an arrangement 10 which is connected (e.g., via a wired connection or a wireless connection) to a communications network 20. In this exemplary embodiment of the system 5, the arrangement 10 includes a communications device 100, a processing device 110 and a storage device 120. The storage device 120 may be a hard drive, a Read-Only-Memory (“ROM”) device, a Read-Access-Memory (“RAM”) device, a laser disk storage device, etc. The communications device 100 may be a network card, a modem, etc. The processing device 110 may be a general purpose microprocessor (e.g., an Intel® Pentium® processor) or a special purpose processor. The communications device 100, the processing device 110 and the storage device 120 preferably communicate with one another via a bus 160 provided in the arrangement 10 using, e.g., a two-way communication scheme. The arrangement 10 can be a multi-purpose computer (e.g., a server, laptop computer, a notebook computer, etc.) or a portable computing device (e.g., a hand-held computing device).

The arrangement 10 utilizes the communications device 100 to connect to the communications network 20. The processing device 110 is connected (via the bus 160) to the communications device 100 for receiving data from and transferring the data to the communications network 20 to be used with devices or other systems. Generally, the user devices can communicate with the arrangement 10 via the communications network 20. These user devices may be a laptop computer 30, a personal computer 40, a personal digital assistant device (e.g. a PalmPilot®) and/or to other devices (e.g., a conventional telephone not which is not shown in the drawings for the sake of clarity). These user devices 30, 40 communicate with the arrangement 10 via the communications network 20 to provide certain information to, and to receive data from the arrangement 10. Such information generally relates to the user's portfolio, the user's risk tolerance, the user's agreement and/or disagreement to the adjustment of the user's portfolio in response to the level of risk in the market, etc. After receiving this information from the user devices, the arrangement 10 may store this information in the storage device 120, and then utilize the stored information to generate particular data, such as an indication to decrease, increase or keep constant the Beta for the user. Thus, based on the information provided from one or more of the user devices 30, 40 and the level of risk in the market, the arrangement 10 is capable of adjusting the user's market exposure based on the level of risk and the user's time horizon.

Other various processing arrangements 50 may be connected to the communications network 20. For example, such arrangements may include a mainframe, a mini-computer, a workstation, etc. that can include a database, and which provide certain real-time or previously stored information via the communication network 20 to the arrangement 10. This real-time or stored financial information may include, but not limited to, Leading versus Coincident Economic Indicators, Fixed Investments, Earning Yield versus T-Bill Yield, Bullish Consensus, IPO Issuance, Money Supply versus Raw Materials Spot Prices, etc. In one exemplary embodiment of the present invention, certain personal information for a particular user can be requested by the arrangement 10 from at least one database 60 via the communications network 20. This personal information can include the user's portfolio, user's previous decisions regarding his or her portfolio or Beta, the user's previously stored guidelines, etc.

The financial information, the user's guidelines and/or the user's personal information can also be received by the arrangement 10 from a data retrieving device 130 that can be connected (either directly, via the communications network 20 or by other communications means) to the arrangement 10. The data retrieving device 130 may be a CD-ROM drive which reads a CD-ROM disks having the user's personal information or guidelines thereon, a tape reading device which reads the user's personal information or guidelines from a data tape, a Zip drive, a hard drive, etc. In particular, this and other exemplary embodiments of the present invention can be Web-based systems. Accordingly, such exemplary systems can be accessed by the users and managers thereof via the Internet or intranet, and the data can also be retrieved by the system, or provided thereby or thereto via the Internet or intranet.

In another embodiment of the system, process and financial engine according to the present invention, the arrangement 10 can be connected to a display device 140 and/or a printing device 150. The display device 140 may be directed, by the arrangement 10, to display the information received from the user, the financial information retrieved from the processing device 50 and/or the data generated by the arrangement 10 based on the user's information and the financial information, as well as the user's portfolio sensitivity. The printing device 150 may also be directed by the arrangement 10 to print the data/information described above.

As shall be described in further detail below, the user may connect to the arrangement 10 (i.e., from the user device and via the communications network 20) to obtain particular information for assisting the user with his or her portfolio and/or to determine whether the portfolio should be adjusted to reflect the market conditions. Upon the connection with the user device (e.g., with at least one of the devices 30, 40), e.g., via the Internet or intranet, the arrangement 10 may transmit a request to the user device to receive the particular information from the user (e.g., user's guidelines establishing the range of Beta exposures, the user's asset allocation guidelines given the portfolio's time horizon and risk tolerance, etc.). This request may prompt certain questions to be displayed to the user at the user device. Some of these questions may be, e.g.:
How long until you expect to make significant withdrawals (e.g., at least 40% of the portfolio's market value) from your portfolio to meet your financial goals?
What is your degree of acceptable volatility of the markets?

Then, the user enters the information in response to these questions, and the entered information is transmitted from the user device to the arrangement 10 via the communications network 20 and the communications device 100. The arrangement also receives the financial information from the processing arrangement 50.

Thereafter, the arrangement 10 may store the received information in the storage device 120 (either temporarily or permanently), and obtain further financial information that would be later used to determine the market risk level from other devices. Upon its receipt and/or retrieval of the user-entered data and the further financial information, the processing device 110 generates the market risk level based on the information received from the processing arrangement 50, and produces certain information which relates to the changes to the user's portfolio sensitivity that is based on the user's time horizon and the determined market risk level. Then, certain recommendations can then be transmitted via the communications network 20 to the storage device of the user, recorded in the database 60, stored in the storage device 120 of the arrangement 10, and/or output on the display device 140 or the printing device 150. The arrangement 10 can also adjust the user's portfolio by changing (or maintaining) the user's target Beta value as shall be described in further detail below. It is also possible for the arrangement 10 to send electronic notifications (e.g., e-mail notices) to the user devices to indicate to the respective user that the user's portfolio sensitivity may need to be adjusted based on the user's market exposure/asset allocation guidelines and the determined market risk.

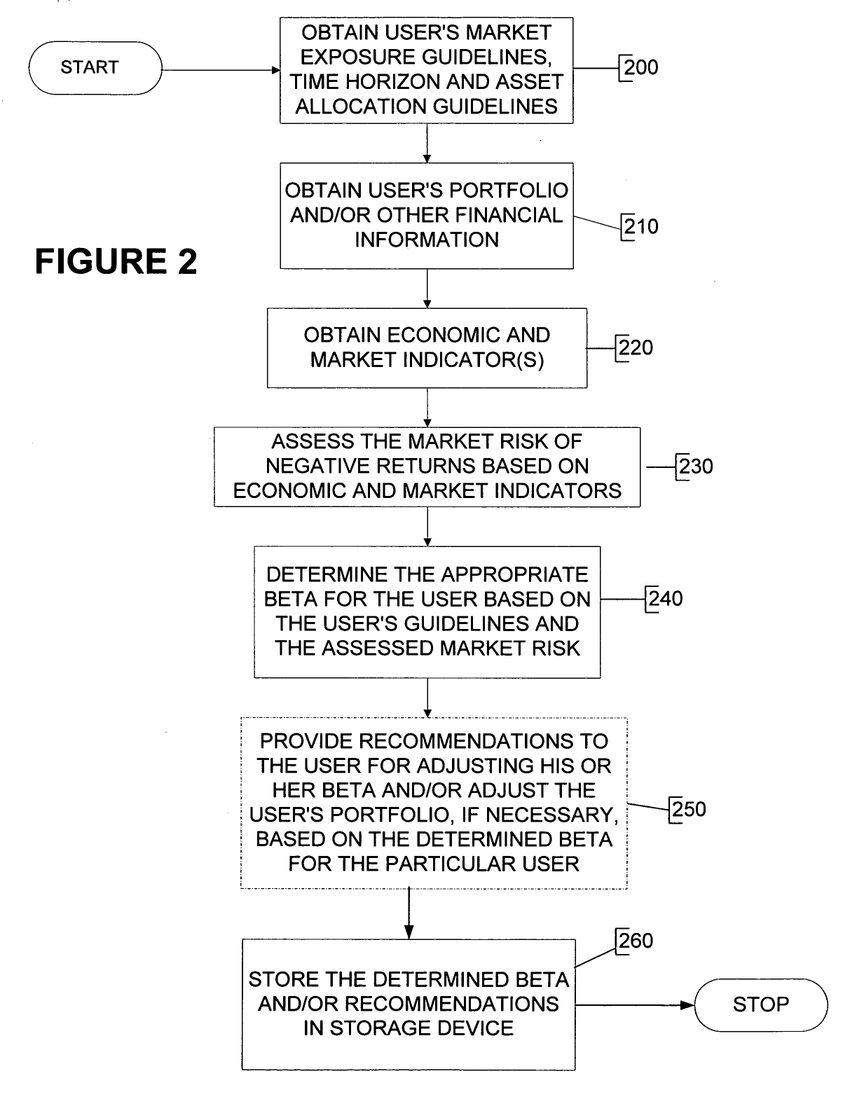

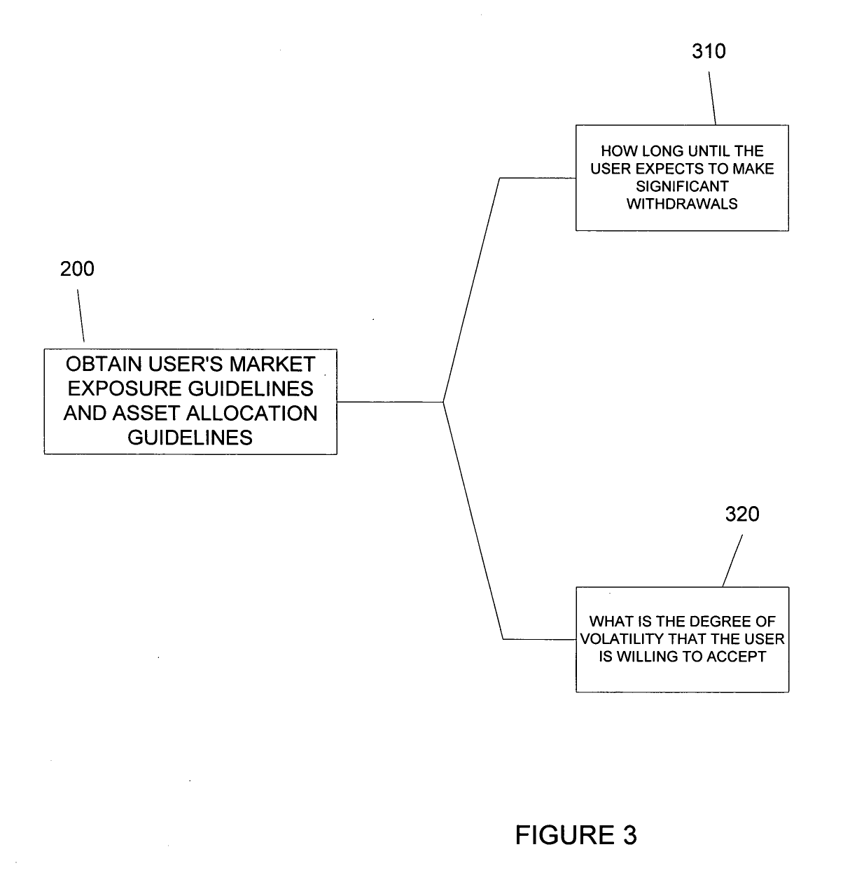

An exemplary embodiment of the process according to the present invention which is capable of determining the current level of market risk, and then recommending changes to (or actually adjusting) the user's portfolio sensitivity based on the user's time horizon and the determined market risk level is shown in FIG. 2. In this exemplary embodiment of the process, in step 200, market exposure guidelines and asset allocation guidelines of the particular user are either obtained from the user device (by the user inputting the information) or retrieved from a storage device (i.e., previously stored information) as described above with reference to FIG. 1. FIG. 3 shows exemplary questions provided to the user so as to obtain the particular user's guidelines. In particular, the system, process and financial engine of the present invention may display the following question at the user device 30, 40:
How long until the user expects to make significant withdrawals (Block 310)?
The following choices may be listed as answers to this question:
   I. 3-5 Years
   II. 6-14 Years
   III. 15 or more years.

At that point, the user would select one of these answers to provide the arrangement 10 his or her time horizon data. Next, the arrangement 10 may display the following question at the user device:
With regards to your investments, select one sentence which best describes you (Block 320).
The following exemplary answer choices may be provided to the user's selection:
   A. I am willing to accept a modest degree of volatility in order to pursue slightly higher returns.
   B. I am willing to accept a higher degree of volatility in order to pursue potentially greater long-term returns.
   C. I am not concerned about the volatility in the value of the equity-type assets in my portfolio as long as I can have the greatest possible potential for growth.

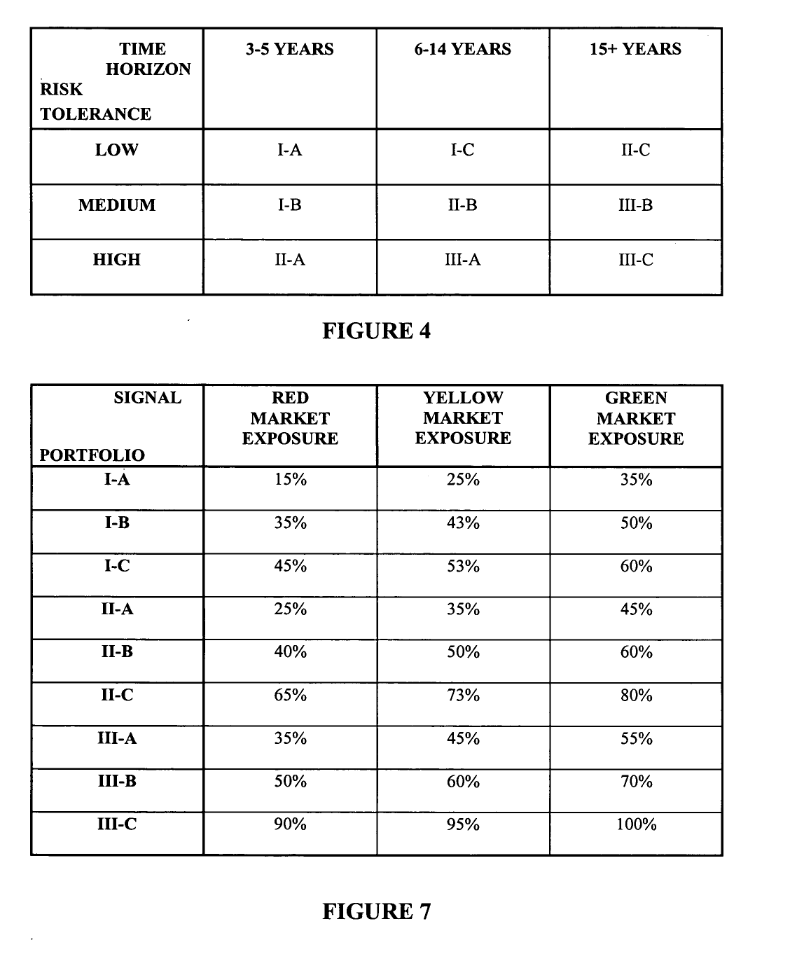

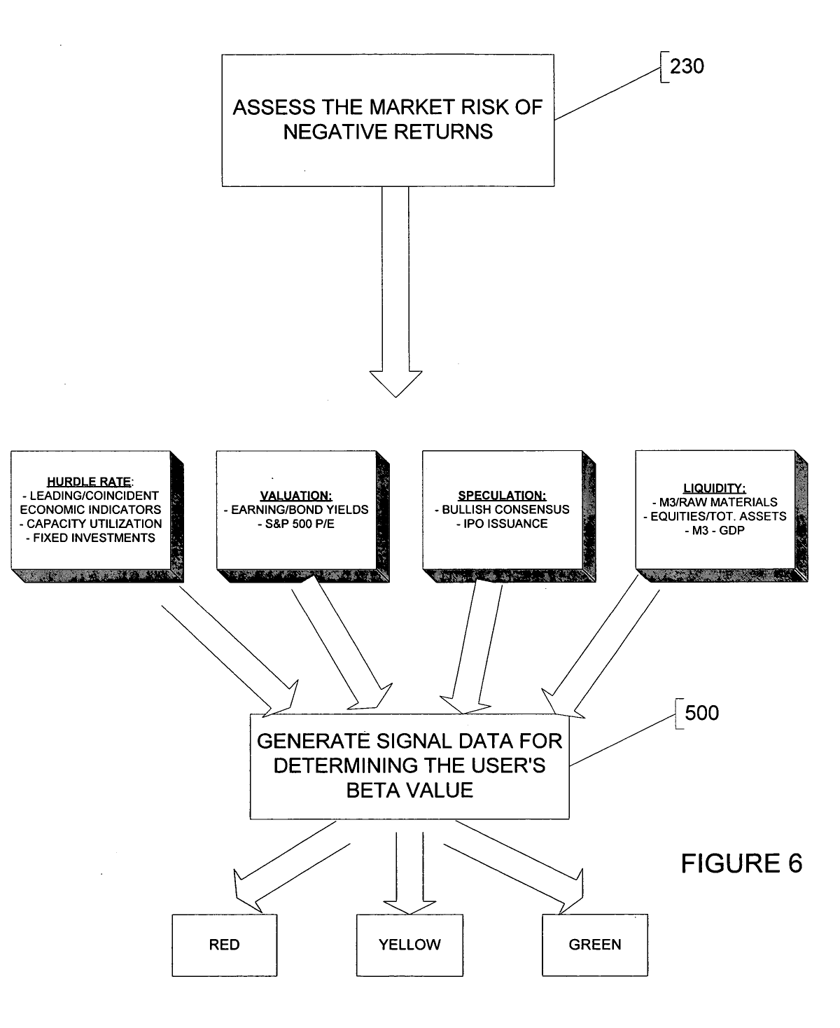

Here, the user may select one of the displayed answers which would correspond to the user's market exposure guidelines, and these guidelines are provided to the arrangement 10. FIG. 4 shows an exemplary table of different combinations of answers that can be achieved for the questions provided to the user in blocks 310 and 320. In this manner, the user's market exposure asset allocation guidelines are determined. For example, choice “A” would correspond to a “Low Risk” tolerance, choice “B” to a “Medium Risk” tolerance, and choice “C” to a “High Risk” tolerance. If the user select “3-5 Years” as his or her answer regarding the user's expectation for significant withdrawals (choice “I”), and then indicates that he or she is willing to accept a higher volatility to pursue a potentially greater return (choice “B” or “Medium Risk”), the user's guideline would be marked as “I-B” in the table of FIG. 6.

After step 200 of FIG. 2 is completed (i.e., the user's market exposure asset allocation guidelines are obtained), the portfolio of the user and/or possibly other financial information for the user is provided to the arrangement 10 (Step 210). These portfolio and/or information can be transmitted from the user device, the processing arrangement 50, and/or the data retrieving device 130.

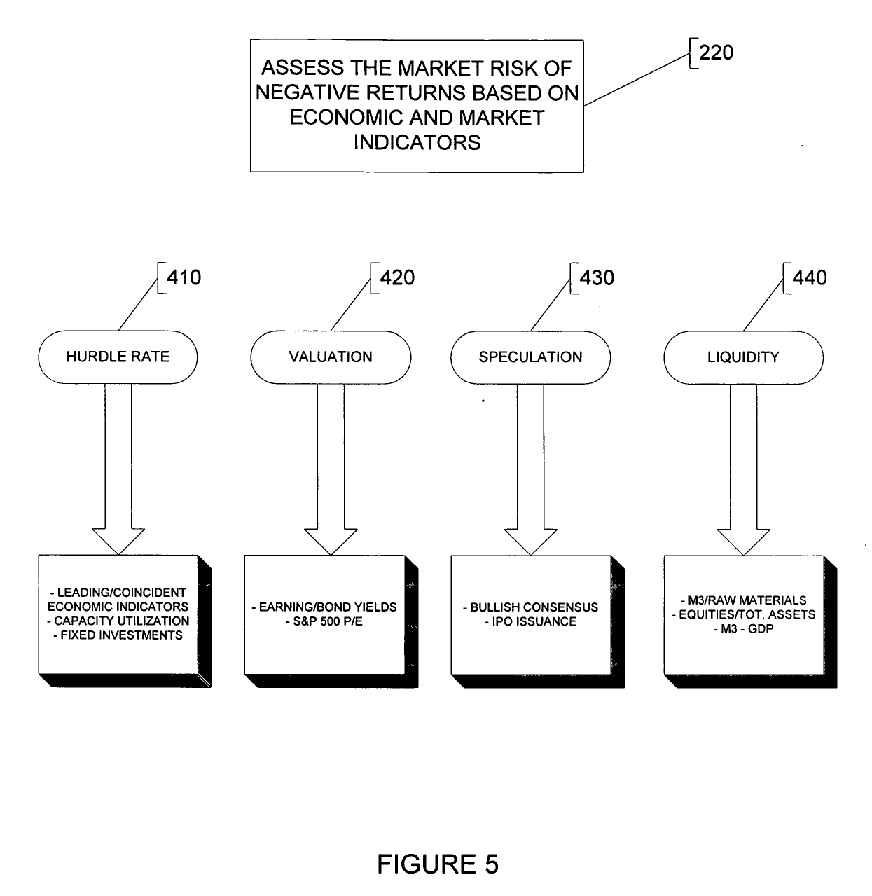

Next, in step 220, the arrangement 10 receives the economic and market indicator(s) via the communications network 20 from the processing arrangement 50, the database 60 and/or other systems or devices. FIG. 5 shows an exemplary diagram of the economic and market indicators which can be retrieved and/or used by the system, process and financial engine of the present invention. In particular, these indicators are arranged in four (4) categories—“Hurdle Rate” 410, “Valuation” 420, “Speculation” 430 and “Liquidity” 440. Discussed below is an exemplary list of indicators provided in the respective categories:

| Category | Indicator (s) |
|---|---|
| Hurdle Rate 410 | Leading versus Coincident Economic Indicators |
| | Capacity Utilization |
| | Fixed Investments |
| Valuation 420 | Earning Yield versus Bond Yield |
| | Standard & Poor's 500 Price/Earnings |
| Speculation 430 | Bullish Consensus |
| | Initial Public Offering Issuance |
| Liquidity 440 | Money Supply (M3) versus Raw Materials Spot Prices |
| | Equities versus Total Assets |
| | Money Supply (M3) versus GDP |

These indicators are utilized based on their historical relevance for identifying periods of sustained bear and bull markets, as well their appropriateness for distinguishing between bear/bull market environments with varying measures of duration and magnitude. Those having ordinary skill in the art should understand that other indicators can be utilized, instead of (or in addition to) the above-referenced indicators, the use of which is within the scope of the present invention.

Next, in step 230, the arrangement 10 performs an assessment of the market risk of negative returns based on the retrieved economic and market indicators. In particular, certain combinations of the above-referenced indicators can be used to generate the Traffic light signal data for determining the user's Beta 500 (see FIG. 6). These signals can be identified as “Red”, “Yellow” or “Green” traffic light signals, as described below. The “Red” light signal promotes caution in the market by indicating, e.g., a high-risk scenario in the economy, and possibly signaling a reduction of Beta for the user's portfolio. The “Green” light signal promotes an opportunity in the market by indicating a low-risk scenario in the economy, and thus signaling an increase of Beta for the user's portfolio. The “Yellow” light signal generally indicates a neutral environment, and affirming that Beta for the user should remain unchanged. When both “Red” and “Green” traffic lights are turned on at the same time, or if neither one of these signal is triggered, the “Yellow” light is turned on by the arrangement 10.

Provided below are examples of the indicators and the combinations thereof that can be used by the arrangement 10 to generate the “Red” traffic signals (indicating a high market risk):

Exemplary Indicators are:
Leading versus Coincident Economic Indicators, Fixed Investments (Hurdle Rate)
Earnings Yield versus T-Bill Yield (Valuation)
Bullish Consensus, IPO Issuance (Speculation)
Money Supply versus Raw Materials Spot Prices (Liquidity)
A. The 12-month moving average in the Leading Economic Indicator has declined for the month while for the Coincident Economic Indicator is still increasing
   It is expected that the economy's momentum would reverse when the leading indicator signals a downturn prior to this realization by the Coincident Economic Indicator. Such a reversal in the economic momentum has historically tended to result in a high risk environment for equity-type assets or securities.
B. The change in the ratio of M3 Money Supply relative to Raw Material Spot Prices has declined more than 10% from the previous year
   This scenario reflects a shift in the excess liquidity. When broad money supply declines relative to the materials prices, it is expected that less liquidity and greater risk in the stock market are present.
C. The change in Fixed Investments has increased more than 10% from the previous year, while Earnings Yield versus Bond Yield (EY/BY) has declined from the previous year
   A significant increase in Fixed Investments may indicate an economy-wide hurdle rate as capacity expands, and optimism for future demand remains high. If this increased capacity occurs when the investors are willing to accept a declining earnings premium in stocks (e.g., a risky asset) relative to certain bonds (e.g., T-Bills), then the risk of a surplus supply affecting stock returns is believed to be high.
D. The change in Fixed Investments has increased more than 10% from the previous year, while the four-week average Bullish Consensus is greater than 70%
   Similar to the previous exemplary combination, a significant increase in Fixed Investments can reflect an economy-wide hurdle rate, while a high bullish consensus, may also reflect extremes in the investors' sentiment. The stock market usually has a higher risk of disappointment when a large capacity increases are met with the evidence of the excessive investor optimism.
E. The 12-month sum of Initial Public Offering (IPO) issues has increased more than 5% from its most recent trough, while the change in EY/BY has declined from the previous year
   An increase in the number of IPOs reflects a shift in investors' sentiment, as the investors are willing to invest in more speculative securities. At the same time, a declining EY/BY relationship causes additional concerns because it reflects a declining earnings premium in stocks, i.e., a risky asset, relative to the yield in the risk-less T-Bills. The combination of the speculation and the high valuations may pose a significant risk for the stock market.

Some examples of the indicators and the combinations thereof that can be used by the arrangement 10 to generate the “Green” traffic signals (indicating a low market risk) are provided below:

Exemplary Indicators are:
Capacity Utilization, Fixed Investments (Hurdle Rate)
S&P 500 Profits/Earnings (Valuation)
Equities versus Total Assets, Money Supply less GDP (Liquidity)
A. The change in Fixed Investments has decreased more than 6% from the previous year
   A significant decrease in Fixed Investments can reflect the supply and demand coming into balance for the economy, thus lowering the risk of owning stocks.
B. Capacity Utilization has dropped below 82% and the change in Fixed Investments is less than 3% from the previous year, while the 2-year average S&P 500 P/E is less than 15
   A Low Capacity Utilization and low growth in Fixed Investments may indicate that economic expectations are low and supply is coming into balance with the demand. If the valuations have also remained low (i.e., S&P 500 P/E<15), then the market risk is considered to be low.
C. Equities as a percent of total assets are below 25%, while the year-over-year change in M3 Money Supply minus the year-over-year change in GDP is less than 3% or has just rebounded a level greater than 3% in the past month
   This is a exemplary combination of two extreme liquidity indicators. When the equities (provided as a percent of total assets) are significantly low, it is probable that additional resources are available to be invested in the equities in the future, most likely at low values. The relationship between the changes in the money supply and the GDP reflects the growth of liquidity relative to the economy. When the economy is growing more rapidly than money supply, a turnaround in money supply and thus liquidity to the stock market is expected to improve. In the midst of such a “liquidity squeeze”, the risk of owning stocks decreases.

Referring to the process of the present invention shown in FIG. 2, in step 240, the arrangement 10 determines the appropriate Beta target for the respective user based on the user's guidelines provided in step 200 and the assessed market risk determined in step 230. This determination is performed using the indicators and the combinations thereof described above. In one exemplary embodiment of the present invention, the arrangement 10 may determine the equity allocation (and thus the user's Beta) using the table provided in FIG. 7. This table may be stored in the in the processing arrangement 50 and/or the database 60, and then transported to the arrangement 10 via the communications network 20. In addition, this table may be stored in the storage device 120 of the arrangement 10, or in the data retrieving device 130 for the use of the arrangement 10.

In this exemplary table of FIG. 7, it is illustrated how the percentage of equity-type assets of the entire portfolio of the user can be determined based on the user's guidelines and the traffic signals (corresponding to the market risks) that are generated by the arrangement 10. Using the example described above, if in steps 200, the user selects “3-5 Years” as his or her answer regarding the user's expectation for significant withdrawals (choice “I”), and then indicates that the user is willing to accept a higher volatility to pursue a potentially greater return (choice “B” or “Medium”), the user's guideline would be marked as “I-B” in the table shown in FIG. 4. Then, in step 240, the arrangement generated the “Red” traffic signal, the arrangement 10 may utilize the table shown FIG. 7 to determine that the percentage of the equity-type securities in the user's portfolio should be 35% (corresponding to 0.35 Beta). However, if the traffic light signal was determined to be “Green”, and based on the information entered by the user in step 200, the user's guideline was set to “I-B”, the percentage of the equity-type securities in the user's portfolio should be 50% (corresponding to 0.5 Beta).

Thereafter, the arrangement 10 can provide recommendations to the user via the user devices 30, 40 for adjusting his or her Beta. In addition or alternatively, the arrangement may adjust the user's portfolio, if warranted, based on the determined Beta for the user. (Step 250). Then, Beta for each user can be stored in the storage device 120 or the database 60 so as to be compared it to new Beta target for the user which would be calculated for the user at a later time.

According to another embodiment of the system, process and engine of the present invention, it is also possible to identify which historical cycles are relevant for the different investors and/or portfolios, and the underlying indicators can be associated with these historical cycles. For example, each historical market cycle for particular equities (e.g., U.S. equities) can be analyzed by the arrangement 10 of the present invention with an emphasis on the high-risk bear markets. Each individual indicator and combination of indicators can be analyzed to determine which one of these indicators (or the combination thereof) tends to signal certain types of cycles relevant for different investor time horizons and/or risk tolerances. In a similar manner, the risk and return characteristics of each cycle may be analyzed to determine which types of the user portfolios can have possibly sustained losses inconsistent with their investment time horizon/risk tolerance in the past. These historical (possibly quantitative) indicators are identified as relevant factors in different horizon/risk-based scenarios, in conjunction with additional qualitative indicators so as to generate the appropriate light signals.

As an example, based on the results from this analysis of the historical market cycles and their risk characteristics, three models can be created and/or monitored to maintain the risk light signals for the user's portfolios. Three exemplary models incorporate the different portfolios using the user's guidelines (shown in FIG. 4) are provided as follows:

| Moderate Horizon | Long-Term Horizon | Maximum Horizon |
|---|---|---|
| I-A | I-C | II-C |
| I-B | II-B | III-B |
| II-A | III-A | III-C |

These models can then be used to determine a Beta target for the user using the appropriate light signals corresponding to the current market risk (in view of the historical cycles). Other exemplary models can also be established, and is within the scope of the present invention.

It should be appreciated that those skilled in the art will be able to devise numerous systems, methods and processes which, although not explicitly shown or described herein, embody the principles of the invention, and are thus within the spirit and scope of the present invention.

1. A process for determining a portfolio's sensitivity to market conditions, comprising the steps of:
receiving first data representative of time horizon information and second data representative of risk tolerance information;
establishing guidelines data based on the first and second data;
receiving further data to calculate particular indicators which are at least one of economic-based indicators and market-based indicators,
establishing at least one market risk signal based on the particular indicators; and
determining the portfolio's sensitivity based on the guidelines data and the market risk signal.

2. The process according to claim 1, further comprising the step of:
determining a target Beta value for the portfolio based on the portfolio's sensitivity.

3. The process according to claim 2, wherein the target Beta value represents a ratio of at least one of equity-type assets and bond-type assets to total assets in the portfolio.

4. The process according to claim 3, further comprising the step of:
adjusting the target Beta value for the portfolio based on the guidelines data and the market risk signal.

5. The process according to claim 3, further comprising the step of:
providing recommendations to an owner of the portfolio based on at least one of the time horizon information and the risk tolerance information of the portfolio for determining if the target Beta value should be adjusted.

6. The process according to claim 1, wherein the portfolio includes at least one of equity-type assets and bond-type assets, and wherein the portfolio's sensitivity relates to the amount of the assets in the portfolio.

7. The process according to claim 1, further comprising the step of:
storing the portfolio's sensitivity; and
receiving at least one further signal which is at least one of a further economic indicator and a further market signal; and
further adjusting the stored portfolio's sensitivity based on the at least one further signal.

8. The process according to claim 7, wherein the portfolio's sensitivity corresponds to a Beta value of the portfolio, and wherein the step of further adjusting the stored portfolio's sensitivity includes at least one of:
providing recommendations to an owner of the portfolio based on portfolio's guidelines for determining if the target Beta value should be adjusted, and adjusting the target Beta value.

9. The process according to claim 1, wherein the first data include information regarding a time period when an owner of the portfolio expects to liquidate a significant portion of the portfolio.

10. The process according to claim 1, wherein the second data include information regarding a degree of volatility in the market that an owner of the portfolio is willing accept.

11. The process according to claim 1, wherein the at least one indicator includes a plurality of indicators, and wherein each of the indicators is identified to be in at least one of the following:
a. a Hurdle Rate category,
b. a Valuation category,
c. a Speculation category, and
d. a Liquidity category.

12. The process according to claim 1, wherein the portfolio's sensitivity corresponds to a Beta value of the portfolio, and wherein the at least one market risk signal indicates one of:
a. an increased market risk,
b. a decreased market risk, and
c. a neutral market risk.

13. The process according to claim 12,
wherein the target Beta value is determined using the guidelines data and at least one market risk signal,
wherein the target Beta value has a first value for an exposure of the increased market risk, a second value for the neutral market risk, and a third value for an exposure of the decreased market risk, and
wherein the first value is greater than the second value, and the second value is greater than the third value.

14. The process according to claim 1, wherein the at least one market risk signal is established based on historical cycles of the market.

15. A system for determining a portfolio's sensitivity to market conditions, comprising:
an arrangement which is configured to:
receive first data representative of time horizon information and second data representative of risk tolerance information,
establish guidelines data based on the first and second data,
receive further data to calculate particular indicators which are at least one of economic-based indicators and market-based indicators,
establish at least one market risk signal based on the particular indicators, and
determine the portfolio's sensitivity based on the guidelines data and the market risk signal.

16. The system according to claim 15, wherein the arrangement is configured to determine a target Beta value for the portfolio based on at least one of portfolio's guidelines and time horizon.

17. The system according to claim 16, wherein the target Beta value represents a ratio of equity-type assets to total assets in the portfolio.

18. The system according to claim 17, wherein the arrangement adjusts the target Beta value for the portfolio based on the guidelines data and the market risk signal.

19. The system according to claim 17, wherein the arrangement provides recommendations to an owner of the portfolio based on the portfolio's sensitivity for determining if the target Beta value should be adjusted.

20. The system according to claim 15, wherein the portfolio includes at least one of equity-type assets and bond-type assets, and wherein the portfolio's sensitivity relates to the amount of the equity-type assets in the portfolio.

21. The system according to claim 15, further comprising:
a storage device, wherein the arrangement:
stores the portfolio's sensitivity in the storage device,
receives at least one further signal which is at least one of a further economic signal and a further market signal, and further adjusts the stored portfolio's sensitivity based on the at least one further signal.

22. The system according to claim 21, wherein the portfolio's sensitivity corresponds to a Beta value of the portfolio, and wherein the arrangement adjusts the stored portfolio's sensitivity by at least one of:
providing recommendations to an owner of the portfolio based on portfolio's guidelines for determining if the target Beta value should be adjusted, and
adjusting the Beta value.

23. The system according to claim 15, wherein the first data include information regarding a time period when an owner of the portfolio expects to liquidate a significant portion of the portfolio.

24. The system according to claim 15, wherein the second data include information regarding a degree of volatility in the market that an owner of the portfolio is willing accept.

25. The system according to claim 15, wherein the at least one indicator includes a plurality of indicators, and wherein each of the indicators is identified to be in at least one of the following:
a. a Hurdle Rate category,
b. a Valuation category,
c. a Speculation category, and
d. a Liquidity category.

26. The system according to claim 15, wherein the portfolio's sensitivity corresponds to a Beta value of the portfolio, and wherein the at least one market risk signal indicates one of:
a. an increased market risk,
b. a decreased market risk, and
c. a neutral market risk.

27. The system according to claim 26,
wherein the Beta value is determined using the guidelines data and the at least one market risk signal,
wherein the Beta value has a first value for the increased market risk, a second value for the neutral market risk, and a third value for the decreased market risk, and
wherein the first value is greater than the second value, and the second value is greater than the third value.

28. The system according to claim 15, wherein the at least one market risk is established based on historical cycles of the market.

29. A financial engine for determining a portfolio's sensitivity to market conditions, comprising:
at least one software module which is capable of being executed by a processing device to:
receive first data representative of time horizon information and second data representative of risk tolerance information,
establish guidelines data based on the first and second data,
receive further data to calculate particular indicators which are at least one of economic-based indicators and market-based indicators,
establish at least one market risk signal based on the at least one indicator, and
determine the portfolio's sensitivity based on the guidelines data and the market risk signal.
